(19) United States
(12) Patent Application Publication
(10) Pub. No.: US 2015/0008081 A1
(43) Pub. Date: Jan. 8, 2015

(54) MAGNETORHEOLOGICAL FLUID SHOCK ABSORBER

(71) Applicant: KAYABA INDUSTRY CO., LTD., Tokyo (JP)

(72) Inventors: Keiji Saito, Tokyo (JP); Kazuhisa Nakamura, Kanagawa (JP); Takashi Teraoka, Gifu (JP)

(73) Assignee: KAYABA INDUSTRY CO., LTD., Tokyo (JP)

(21) Appl. No.: 14/380,185

(22) PCT Filed: Feb. 18, 2013
(86) PCT No.: PCT/JP2013/053866

§ 371 Date: Aug. 21, 2014

(30) Foreign Application Priority Data
Mar. 1, 2012 (JP) 2012-045745

(51) Int. Cl. F16F 9/53; F16F 9/32

(52) U.S. Cl. CPC F16F 9/535; F16F 9/3214
USPC 188/267

(57) ABSTRACT

A magnetorheological fluid shock absorber includes a piston slidably arranged in a cylinder in which magnetorheological fluid whose viscosity changes by the action of a magnetic field is sealed. The piston includes a piston core which is attached to an end part of the piston rod and on the outer periphery of which a coil is provided, a flux ring which surrounds the outer periphery of the piston core and forms a flow passage for the magnetorheological fluid between the piston core and the flux ring, a plate which is annularly formed, arranged on the outer periphery of the piston rod and attached to one end of the flux ring, and a stopper whose axial position is specified with respect to the piston rod and which sandwiches the plate between the piston core and the stopper.

### TECHNICAL FIELD

The present invention relates to a magnetorheological fluid shock absorber utilizing magnetorheological fluid whose apparent viscosity changes by the action of a magnetic field.

### BACKGROUND ART

A shock absorber which changes a damping force by causing a magnetic field to act on a flow passage in which the magnetorheological fluid passes and changing an apparent viscosity of magnetorheological fluid is known as a shock absorber installed in a vehicle such as an automotive vehicle. JP2008-175364A discloses a magnetorheological fluid shock absorber in which magnetorheological fluid passes in a flow passage formed between a piston core having a coil wound on the outer periphery thereof and a piston ring arranged on the outer periphery of the piston core when a piston assy including the piston core and the piston ring slides in a cylinder.

### SUMMARY OF INVENTION

However, in the magnetorheological fluid shock absorber of JP2008-175364A, a pair of plates for sandwiching the piston ring in an axial direction are provided and each plate is fixed by fastening a nut to arrange the piston ring at a predetermined position with respect to the piston core. Since the piston ring is fixed by being sandwiched by the plates and the nuts from opposite end sides in this way, the entire length of the piston assy becomes longer, which may lead to a shorter stroke length of the piston assy.

The present invention was developed in view of the above problem and aims to shorten the entire length of a piston of a magnetorheological fluid shock absorber.

According to one aspect of this invention, a magnetorheological fluid shock absorber, including: a cylinder in which magnetorheological fluid whose viscosity changes by the action of a magnetic field is sealed; a piston which is slidably arranged in the cylinder and defines a pair of fluid chambers in the cylinder; and a piston rod which is coupled to the piston and extends to the outside of the cylinder; is provided. The piston includes: a piston core which is attached to an end part of the piston rod and on the outer periphery of which a coil is provided; a flux ring which surrounds the outer periphery of the piston core and forms a flow passage for the magnetorheological fluid between the piston core and the flux ring; a plate which is annularly formed, arranged on the outer periphery of the piston rod and attached to one end of the flux ring; and a stopper whose axial position is specified with respect to the piston rod and which sandwiches the plate between the piston core and the stopper.

The details as well as other features and advantages of this invention are set forth in the remainder of the specification and are shown in the accompanying drawings.

### BRIEF DESCRIPTION OF DRAWINGS

FIG. 1 is a front sectional view of a magnetorheological fluid shock absorber according to an embodiment of the present invention,

FIG. 2 is a left side view of a piston in FIG. 1, and

FIG. 3 is a right side view of the piston in FIG. 1.

### DESCRIPTION OF EMBODIMENTS

Hereinafter, an embodiment of the present invention is described with reference to the drawings.

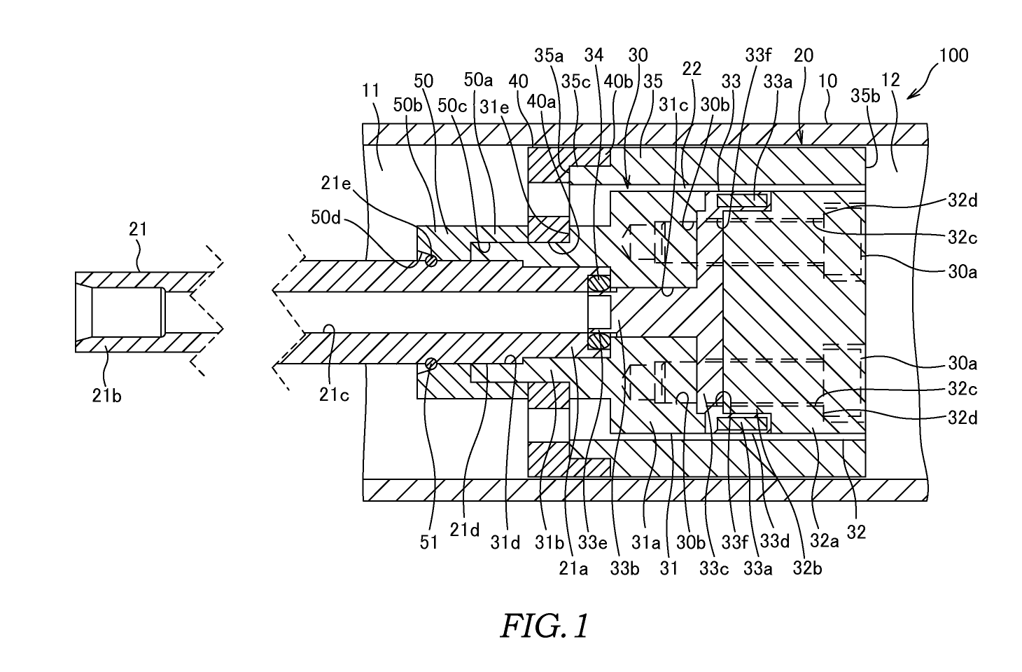

First, the overall configuration of a magnetorheological fluid shock absorber 100 according to the embodiment of the present invention is described with reference to FIG. 1.

The magnetorheological fluid shock absorber 100 is a shock absorber whose damping coefficient is variable due to the use of magnetorheological fluid whose viscosity changes by the action of a magnetic field. The magnetorheological fluid shock absorber 100 includes a cylinder 10 in which the magnetorheological fluid is sealed, a piston 20 which is slidably arranged in the cylinder 10, and a piston rod 21 which is coupled to the piston 20 and extends to the outside of the cylinder 10.

The cylinder 10 is formed into a bottomed cylindrical shape. The magnetorheological fluid sealed in the cylinder 10 is liquid whose apparent viscosity changes by the action of a magnetic field and in which ferromagnetic fine particles are dispersed in liquid such as oil. A viscosity of the magnetorheological fluid changes according to an intensity of the acting magnetic field and returns to an initial state when there is no more influence of the magnetic field.

The piston 20 defines a fluid chamber 11 and a fluid chamber 12 in the cylinder 10. The piston 20 includes an annular flow passage 22 which enables a movement of the magnetorheological fluid between the fluid chambers 11 and 12. The piston 20 can slide in the cylinder 10 by the passage of the magnetorheological fluid in the flow passage 22. The configuration of the piston 20 is described in detail later.

The piston rod 21 is formed coaxially with the piston 20. One end 21a of the piston rod 21 is fixed to the piston 20 and another end 21b thereof extends to the outside of the cylinder 10. The piston rod 21 is formed into such a bottomed cylindrical shape that the one end 21a is open and the other end 21b is closed. A pair of wires (not shown) for supplying a current to a coil 33a of the piston 20 to be described later are passed along an inner periphery 21c of the piston rod 21. An external thread 21d to be threadably engaged with the piston 20 and an annular groove 21e formed in conformity with the outer shape of a C-ring 51 to be described later in correspondence with a position where the C-ring 51 is provided are formed on the outer periphery of the piston rod 21 near the one end 21a.

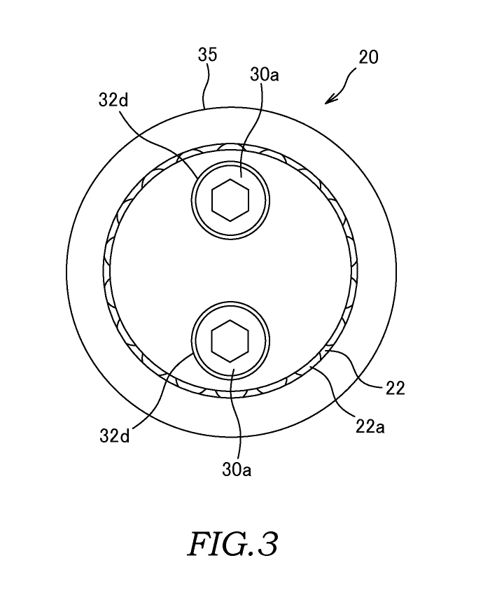

Next, the configuration of the piston 20 is described with reference to FIGS. 1 to 3.

The piston 20 includes a piston core 30 which is attached to an end part of the piston rod 21 and on the outer periphery of which the coil 33a is provided, and a flux ring 35 which surrounds the outer periphery of the piston core 30 and forms the flow passage 22 for the magnetorheological fluid between the piston core 30 and the flux ring 35. The piston 20 includes a plate 40 which is formed into an annular shape, arranged on the outer periphery of the piston rod 21 and attached to one end 35a of the flux ring 35, a stopper 50 whose axial position is specified with respect to the piston rod 21 and which sandwiches the plate 40 between the piston core 30 and the stopper 50, and the C-ring 51 which serves as a snap ring for fixing the stopper 50 in the axial direction by being fitted to the inner periphery of the stopper 50.

The piston core 30 includes a first core 31 which is attached to an end part of the piston rod 21, a coil assembly 33 provided on the outer periphery of the coil 33a, a second core 32 which sandwiches the coil assembly 33 between the first core 31 and the second core 32, and a pair of bolts 30a as fastening members for fastening the second core 32 and the coil assembly 33 to the first core 31.

The first core 31 includes a large diameter portion 31a whose outer periphery faces the inner periphery of the flux ring 35, a small diameter portion 31b which is formed to have a smaller diameter than the large diameter portion 31a, and a through hole 31c which penetrates through a center in the axial direction.

The large diameter portion 31a is formed into a cylindrical shape. The outer periphery of the large diameter portion 31a faces the flow passage 22 in which the magnetorheological fluid passes. The large diameter portion 31a is held in contact with the coil assembly 33. A cylindrical portion 33b of the coil assembly 33 to be described later is inserted and fitted into the through hole 31c of the large diameter portion 31a. The large diameter portion 31a is formed with a pair of internal threads 30b with which the bolts 30a are to be threadably engaged.

The small diameter portion 31b is formed continuously and coaxially with the large diameter portion 31a. The small diameter portion 31b is formed into a cylindrical shape projecting in the axial direction from the flux ring 35. An internal thread 31d to be threadably engaged with the external thread 21d of the piston rod 21 is formed on the inner periphery of the small diameter portion 31b. The piston core 30 is fastened to the piston rod 21 by the threadable engagement of the external thread 21d and the internal thread 31d.

An annular step portion 31e is formed on the outer periphery of an end part of the small diameter portion 31b connected to the large diameter portion 31a. The plate 40 is in contact with the step portion 31e and is sandwiched between the stopper 50 and the step portion 31e.

The second core 32 includes a large diameter portion 32a whose outer periphery faces the inner periphery of the flux ring 35, a small diameter portion 32b which is formed on one end of the large diameter portion 32a to have a smaller diameter than the large diameter portion 32a, through holes 32c through which the bolts 30a penetrate, and deep counterbore portions 32d with which the heads of the bolts 30a are to be engaged.

The large diameter portion 32a is formed into a cylindrical shape. The large diameter portion 32a is formed to have the same diameter as the large diameter portion 31a of the first core 31. The outer periphery of the large diameter portion 32a faces the flow passage 22 in which the magnetorheological fluid passes. The large diameter portion 32a is so formed that an end surface facing the fluid chamber 12 is flush with another end 35b of the flux ring 35.

The small diameter portion 32b is formed into a cylindrical shape coaxial with the large diameter portion 32a. The small diameter portion 32b is formed to have the same diameter as the inner periphery of a coil molding portion 33d of the coil assembly 33 to be described later and fitted to the inner periphery of the coil molding portion 33d.

A pair of through holes 32c are formed to penetrate through the second core 32 in the axial direction. The through holes 32c are formed to have a larger diameter than threadably engaging portions of the bolts 30a. The through holes 32c are formed to be coaxial with the internal threads 30b of the first core 31 in an assembled state of the piston core 30.

The deep counterbore portions 32d are formed on end parts of the through holes 32c. The deep counterbore portions 32d are formed to have a larger diameter than the through holes 32c and the heads of the bolts 30a. The deep counterbore portions 32d are formed to have such a depth that the heads of the bolts 30a can be completely accommodated. When the bolts 30a inserted into the through holes 32c are threadably engaged with the internal threads 31d of the first core 31, the bottom surfaces of the deep counterbore portions 32d are pressed toward the first core 31 and the second core 32 is pressed against the first core 31.

The coil assembly 33 is formed by molding in a state where the coil 33a is inserted. The coil assembly 33 includes a cylindrical portion 33b to be fitted into the through hole 31c of the first core 31, a flat plate portion 33c to be sandwiched between the first core 31 and the second core 32 and the coil molding portion 33d having the coil 33a provided inside.

The coil 33a forms a magnetic field by an externally supplied current. An intensity of this magnetic field increases with an increase in the current supplied to the coil 33a. When the current is supplied to the coil 33a and the magnetic field is formed, the apparent viscosity of the magnetorheological fluid flowing in the flow passage 22 changes. The viscosity of the magnetorheological fluid increases with an increase in the intensity of the magnetic field by the coil 33a.

A tip part 33e of the cylindrical portion 33b is fitted to the inner periphery of the piston rod 21. A pair of wires for supplying a current to the coil 33a are pulled out from the tip of the cylindrical portion 33b. An O-ring 34 as a sealing member is provided between the tip part 33e of the cylindrical portion 33b and the one end 21a of the piston rod 21.

The O-ring 34 is axially compressed by the large diameter portion 31a of the first core 31 and the piston rod 21 and radially compressed by the tip part 33e of the coil assembly 33 and the piston rod 21. This prevents the magnetorheological fluid having intruded into between the outer periphery of the piston rod 21 and the first core 31 and between the first core 31 and the coil assembly 33 from flowing out to the inner periphery of the piston rod 21 and leaking therefrom.

The flat plate portion 33c is formed into a disk shape continuous and coaxial with a base end part of the cylindrical portion 33b. The pair of wires for supplying the current to the coil 33a pass through the flat plate portion 33c and the cylindrical portion 33b. The flat plate portion 33c includes through holes 33f through which the bolts 30a penetrate.

The through holes 33f are formed to have the same diameter as the through holes 32c of the second core 32. The through holes 33f are formed to be coaxial with the internal threads 30b of the first core 31 and continuous with the through holes 32c in the assembled state of the piston core 30.

The coil molding portion 33d is annularly raised on an outer edge part of the flat plate portion 33c. The coil molding portion 33d is formed to project from an end part of the coil assembly 33 opposite to the cylindrical portion 33b. The coil molding portion 33d is formed to have the same diameter as the large diameter portion 31a of the first core 31. The outer periphery of the coil molding portion 33d faces the flow passage 22 in which the magnetorheological fluid passes. The coil 33a is provided in the coil molding portion 33d.

As just described, the piston core 30 is formed by being divided into three members, i.e. the first core 31, the second core 32, and the coil assembly 33. Thus, only the coil assembly 33 provided with the coil 33a may be formed by molding and sandwiched between the first core 31 and the second core 32. Thus, the piston core 30 is easily formed as compared with the case where a molding operation is performed by forming the piston core 30 by a single member.

In the piston core 30, the first core 31 is fixed to the piston rod 21, but the coil assembly 33 and the second core 32 are only fitted in the axial direction. Accordingly, in the piston 20, the second core 32 and the coil assembly 33 are so fixed as to be pressed against the first core 31 by tightening the pair of bolts 30a.

The bolts 30a are inserted through the through holes 32c of the second core 32 and the through holes 33f of the coil assembly 33 to be threadably engaged with the internal threads 30b of the first core 31. The bolts 30a press the bottom surfaces of the deep counterbore portions 32d toward the first core 31 by tightening forces thereof. This causes the coil assembly 33 to be sandwiched between the second and first cores 32, 31, whereby the piston core 30 is formed into an integrated body.

In this way, only by tightening the bolts 30a, the second core 32 and the coil assembly 33 are fixed by being pressed against the first core 31. Thus, the piston core 30 can be easily assembled.

The flux ring 35 is formed into a substantially cylindrical shape. The outer periphery of the flux ring 35 is formed to have substantially the same diameter as the inner periphery of the cylinder 10. The inner periphery of the flux ring 35 faces the outer periphery of the piston core 30. The inner periphery of the flux ring 35 is formed to have a larger diameter than the outer periphery of the piston core 30 and forms the flow passage 22 between the piston core 30 and this inner periphery. The flux ring 35 is fixed to the piston core 30 via the plate 40 to be coaxial with the piston core 30.

The flux ring 35 includes a small diameter portion 35c which is formed on the inner periphery of the one end 35a and to which the plate 40 is to be fitted. The small diameter portion 35c is formed to have a smaller diameter than the other part of the flux ring 35 so that the plate 40 is fitted to the outer periphery.

The plate 40 is for specifying the axial position of the flux ring 35 with respect to the piston core 30 by supporting the one end 35a of the flux ring 35. The outer periphery of the plate 40 is formed to have the same diameter as the outer periphery of the flux ring 35.

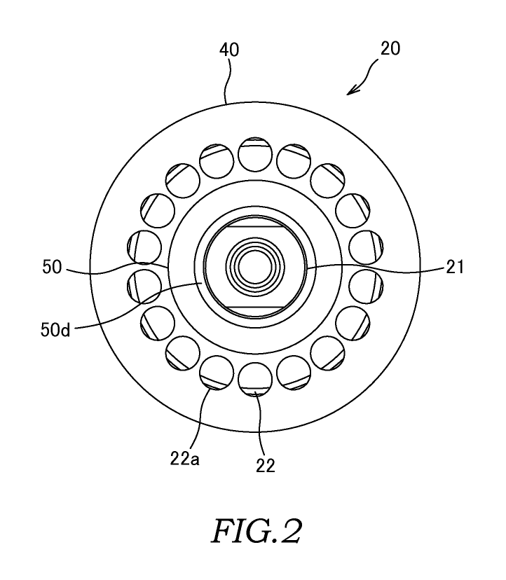

As shown in FIG. 2, the plate 40 includes a plurality of flow passages 22a which are through holes communicating with the flow passage 22. The flow passages 22a are formed to have a circular shape and annularly arranged at equal intervals.

A through hole 40a into which the small diameter portion 31b of the first core 31 is fitted is formed on the inner periphery of the plate 40. Coaxiality between the plate 40 and the first core 31 is ensured by fitting the small diameter portion 31b into the through hole 40a.

An annular jaw portion 40b to be fitted to the small diameter portion 35c of the one end 35a of the flux ring 35 is formed on the outer periphery of the plate 40. The jaw portion 40b is formed to project toward the flux ring 35. The jaw portion 40b is fixed by being brazed to the small diameter portion 35c. The plate 40 and the flux ring 35 may be fixed by welding, fastening or the like instead of brazing.

The plate 40 is sandwiched by being pressed against the stopper 50 by a fastening force of the piston core 30 to the piston rod 21. In this way, the axial position of the flux ring 35 fixed to the plate 40 with respect to the piston core 30 is specified.

The stopper 50 is formed into a substantially cylindrical shape and fitted to the outer periphery of the small diameter portion 31b of the first core 31. A tip part 50a of the stopper 50 comes into contact with the plate 40. The stopper 50 includes a large diameter portion 50c, which is to be fitted to the outer periphery of the small diameter portion 31b, on the inner periphery of the tip part 50a. The stopper 50 includes a tapered portion 50d formed into a tapered shape widened toward an end surface on the inner periphery surface of a base end part 50b.

The large diameter portion 50c is formed to face the plate 40. The large diameter portion 50c is formed to have an inner diameter substantially equal to an inner diameter of the plate 40. An end surface of the tip part 50a of the large diameter portion 50c is formed in parallel to an end surface of the plate 40 and comes into surface contact with the plate 40.

The tapered portion 50d comes into contact with the C-ring 51. In a state where the tapered portion 50d is in contact with the C-ring 51, the stopper 50 can no longer move in the axial direction toward the other end 21b of the piston rod 21.

The C-ring 51 is a ring formed to have a circular cross-section. The C-ring 51 is in the form of a C-shaped ring, and a part of the circumference thereof is open. The C-ring 51 is fitted to the annular groove 21e by a radially inwardly contracting force. The C-ring 51 comes into contact with the tapered portion 50d of the stopper 50 to specify the axial position of the base end part 50b of the stopper 50.

As described above, the plate 40 attached to the one end 35a of the flux ring 35 is sandwiched by the piston core 30 attached to the end part of the piston rod 21 and the stopper 50 whose axial position is specified with respect to the piston rod 21. This causes the flux ring 35 to be fixed to the piston core 30 in the axial direction. Thus, in order to specify the axial position of the flux ring 35, it is not necessary to provide another member projecting in the axial direction from the other end 35b of the flux ring 35. Therefore, the entire length of the piston 20 of the magnetorheological fluid shock absorber 100 can be shortened.

An example of an assembling procedure of the piston 20 is described below.

First, the first core 30 is assembled. First, the coil assembly 33 is attached to the first core 31. The cylindrical portion 33b of the coil assembly 33 is inserted into the through hole 31c of the first core 31 from the side of the large diameter portion 31a and the pair of wires for supplying a current to the coil 33a are pulled out from the through hole 31c of the first core 31 on the side of the small diameter portion 31b.

Subsequently, the second core 32 is attached to the coil assembly 33. Specifically, the second core 32 is so attached that the small diameter portion 32b of the second core 32 is fitted to the inner periphery of the coil molding portion 33d of the coil assembly 33. Then, the pair of bolts 30a are threadably engaged with the internal threads 31d of the first core 31 after being passed through the through holes 32c of the second core 32 and the through holes 33f of the coil assembly 33. By the tightening of these bolts 30a, the assembling of the piston core 30 is completed.

In parallel with the assembling of the piston core 30, the flux ring 35 and the plate 40 are integrally assembled. Specifically, the jaw portion 40b of the plate 40 is fitted and brazed to the small diameter portion 35c of the flux ring 35.

Then, the plate 40 integrally assembled with the flux ring 35 is assembled with the piston core 30. Specifically, the plate 40 is fitted to the outer periphery of the small diameter portion 31b of the first core 31 of the piston core 30 and brought into contact with the step portion 31e of the first core 31. In this state, the plate 40 is only in contact with the step portion 31e and not fixed in the axial direction.

Subsequently, the piston rod 21 and the stopper 50 are assembled. First, the C-ring 51 is fitted to the annular groove 21e of the piston rod 21. Then, the stopper 50 is fitted from the one end 21a of the piston rod 21. The axial position of the stopper 50 is specified by the C-ring 51 coming into contact with the tapered portion 50d on the inner peripheral surface of the base end part 50b.

Finally, the piston rod 21 and the piston core 30 are assembled. Specifically, the internal thread 31d of the first core 31 of the piston core 30 and the external thread 21d of the piston rod 21 are threadably engaged. At this time, the O-ring 34 is inserted in advance between the tip part 33e of the piston rod 21 and the one end 21a of the piston rod 21.

As the piston core 30 is rotated relative to the piston rod 21, the plate 40 assembled with the piston core 30 in advance is sandwiched between the step portion 31e of the first core 31 of the piston core 30 and the tip part 50a of the stopper 50. In this way, the assembling of the piston 20 is completed.

As just described, the plate 40 is pressed against and fixed to the stopper 50 by the fastening force of the first core 31 of the piston core 30 to the piston rod 21. Thus, the piston 20 can be easily assembled only by fastening the piston core 30 to the piston rod 21. Further, since each member of the piston 20 can be firmly fixed by the fastening force of the piston core 30, the rotation of each member is prevented and vibration is suppressed.

It should be noted that, in the present embodiment, the piston 20 is divided into the three members, i.e. the first core 31, the second core 32, and the coil assembly 33. However, instead of this configuration, the first core 31 and the coil assembly 33 may be integrally formed so that the piston 20 is composed of two members or the second core 32 and the coil assembly 33 may be integrally formed so that the piston 20 is composed of two members.

Further, without being limited to the assembling procedure described above, it is, for example, possible to fasten only the first core 31 to the piston rod 21 such that the plate 40 is sandwiched between the stopper 50 and the first core 31 and then assemble the coil assembly 33 and the second core 32 and fasten them by the bolts 30a.

According to the above embodiment, the following effects are achieved.

The plate 40 attached to the one end 35a of the flux ring 35 is sandwiched by the piston core 30 attached to the end part of the piston rod 21 and the stopper 50 whose axial position is specified with respect to the piston rod 21. This causes the flux ring 35 to be fixed in the axial direction with respect to the piston core 30. Thus, in order to specify the axial position of the flux ring 35, it is not necessary to provide another member projecting in the axial direction from the other end 35b of the flux ring 35. Therefore, the entire length of the piston 20 of the magnetorheological fluid shock absorber 100 can be shortened.

Further, the piston core 30 is formed by being divided into three members, i.e. the first core 31, the second core 32, and the coil assembly 33. Thus, only the coil assembly 33 provided with the coil 33a may be formed by molding and sandwiched between the first core 31 and the second core 32. Therefore, the piston core 30 is easily formed as compared with the case where a molding operation is performed by forming the piston core 30 by a single member.

The plate 40 to which the flux ring 35 is integrally fixed is fixed by being pressed against the stopper 50 by the fastening force of the first core 31 of the piston core 30 to the piston rod 21. Thus, the piston 20 can be easily assembled only by fastening the piston core 30 to the piston rod 21.

Embodiments of this invention were described above, but the above embodiments are merely examples of applications of this invention, and the technical scope of this invention is not limited to the specific constitutions of the above embodiments.

For example, in the magnetorheological fluid shock absorber 100, the pair of wires for supplying a current to the coil 33a pass along the inner periphery of the piston rod 21. Thus, a ground for allowing the current applied to the coil 33a to escape to the outside can be eliminated. However, instead of this configuration, the current may be grounded to the outside through the piston rod 21 itself by letting only one wire for applying the current to the coil 33a pass through the interior of the piston rod 21.

This application claims priority based on Japanese Patent Application No. 2012-045745 filed with the Japan Patent Office on Mar. 1, 2012, the entire contents of which are incorporated into this specification.

The embodiments of this invention in which an exclusive property or privilege is claimed are defined as follows:

1. A magnetorheological fluid shock absorber, comprising:
a cylinder in which magnetorheological fluid whose viscosity changes by the action of a magnetic field is sealed;
a piston which is slidably arranged in the cylinder and defines a pair of fluid chambers in the cylinder; and
a piston rod which is coupled to the piston and extends to the outside of the cylinder;
wherein the piston includes:
a piston core which is attached to an end part of the piston rod and on the outer periphery of which a coil is provided;
a flux ring which surrounds the outer periphery of the piston core and forms a flow passage for the magnetorheological fluid between the piston core and the flux ring;
a plate which is annularly formed, arranged on the outer periphery of the piston rod and attached to one end of the flux ring; and
a stopper whose axial position is specified with respect to the piston rod and which sandwiches the plate between the piston core and the stopper.

2. The magnetorheological fluid shock absorber according to claim 1, further comprising:
a snap ring which fixes the stopper in an axial direction by being fitted to the inner periphery of the stopper.

3. The magnetorheological fluid shock absorber according to claim 2, wherein:
an annular groove is formed in correspondence with a position, where the snap ring is provided, on the outer periphery of the piston rod; and
the snap ring is fitted to the annular groove by a radially inwardly contracting force.

4. The magnetorheological fluid shock absorber according to claim 2, wherein:
the snap ring is the form of a C-shaped ring, a part of the circumference of which is open;
a tip part of the stopper comes into contact with the plate; and
a tapered portion which is formed into a tapered shape widened toward an end surface and comes into contact with the snap ring is formed at a base end part of the stopper.

5. The magnetorheological fluid shock absorber according to claim 1, wherein:
the piston core is fastened to the piston rod; and
the plate is sandwiched by being pressed against the stopper by a fastening force of the piston core.

6. The magnetorheological fluid shock absorber according to claim 1, wherein the piston core includes:
a first core which is attached to an end part of the piston rod and comes into contact with the plate;
a coil assembly on the outer periphery of which the coil is provided;
a second core which sandwiches the coil assembly between the first core and the second core; and
a fastening member which fastens the second core and the coil assembly to the first core.
